(19) United States
(12) Patent Application Publication
(10) Pub. No.: US 2021/0329598 A1
(43) Pub. Date: Oct. 21, 2021

(54) A METHOD, DEVICE AND COMPUTER READABLE MEDIA FOR SIDELINK CONFIGURATION TRANSMISSION AND RECEPTION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 17/270,240

(22) PCT Filed: Aug. 24, 2018
(86) PCT No.: PCT/CN2018/102357

§ 371 Date: Feb. 22, 2021

(51) Int. Cl. H04W 72/02; H04W 72/04; H04W 72/10; H04W 72/08; H04W 56/00; H04W 4/40

(52) U.S. Cl. CPC H04W 72/02; H04W 72/0453; H04W 4/40; H04W 72/085; H04W 56/001; H04W 72/10

(57) ABSTRACT

Embodiments of the present disclosure relate to a method, device and computer readable medium for sidelink configuration transmission and reception in vehicle to everything (V2X) communication. In an embodiment of the present disclosure, a method for transmitting sidelink configuration is performed at a terminal device. In the method, association relationship between a primary sidelink carrier carrying sidelink configuration information of the primary sidelink carrier and one or more complementary sidelink carriers is obtained; and sidelink configuration information of the one or more complementary sidelink carriers is transmitted on the primary sidelink carrier based on the association relationship.

### FIELD OF THE INVENTION

The non-limiting and exemplary embodiments of the present disclosure generally relate to the field of wireless communication techniques, and more particularly relate to a method, device and computer readable medium for sidelink configuration transmission in vehicle to everything (V2X) communication, and a method, device and computer readable medium for sidelink configuration reception in V2X communication.

### BACKGROUND OF THE INVENTION

This section introduces aspects that may facilitate better understanding of the disclosure. Accordingly, the statements of this section are to be read in this light and are not to be understood as admissions about what is in the prior art or what is not in the prior art.

New radio access system, which is also called as NR system or NR network, is the next generation communication system. In Radio Access Network (RAN) #71 meeting for the third generation Partnership Project (3GPP) working group, study of the NR system was approved. The NR system will consider frequency ranging up to 100 Ghz with an object of a single technical framework addressing all usage scenarios, requirements and deployment scenarios defined in Technical Report TR 38.913, which includes requirements such as enhanced mobile broadband, massive machine-type communications, and ultra-reliable and low latency communications.

The V2X communication is a technology passing of information from a vehicle to any entity that may affect the vehicle, and vice versa. It is a vehicular communication system that incorporates various specific types of communication like V2I (Vehicle-to-Infrastructure), V2N (Vehicle-to-network), V2V (Vehicle-to-vehicle), V2P (Vehicle-to-Pedestrian), V2D (Vehicle-to-device) and V2G (Vehicle-to-grid). The main motivations for V2X are road safety, traffic efficiency, and energy savings.

The V2X communication was implemented in 3GPP Rel-14. User Equipment (UE) in a vehicle could use a network device like evolved node B (eNB), Global Navigation Satellite Systems (GNSS), or another UE as a synchronization reference for the sidelink carrier, and the carrier of the synchronization reference base station can be different from the sidelink carrier. The V2X communication was further enhanced in 3GPP Rel-15, wherein sidelink carrier aggregation was introduced, and for a UE with multiple aggregated sidelink carriers, a single synchronization reference is used for all the aggregated carriers.

In the LTE V2X communication, if UE satisfies predetermined transmission conditions, it should transmit sidelink synchronization signal (SLSS)/physical sidelink broadcast channel (PSBCH) on one or more carriers based on its transmission (TX) capability and network configuration. The UE selects a synchronization reference according to synchronization reference priority order if there are more than one synchronization references detected.

In 3GPP RAN #80 meeting, a Study Item (SI) was already approved with a target to support advanced V2X use cases defined 3GPP TR 22.886, and the NR V2X is supposed to complement LTE V2X instead of replacing it. For the NR V2X communication, to adapt to the new synchronization scenario, there are several aspects to be studied including sidelink design, Uu enhancements for advanced V2X use cases, Uu-based sidelink resource allocation/configuration, Radio Access Technology (RAT)/Interface selection for operation, QoS management, and coexistence.

### SUMMARY OF THE INVENTION

In general, example embodiments of the present disclosure provide new solutions for sidelink configuration transmission and reception in V2X communication.

According to a first aspect of the present disclosure, there is provided a method for transmitting sidelink configuration in V2X communication. The method is performed at the terminal device and may include obtaining association relationship between a primary sidelink carrier carrying sidelink configuration information of the primary sidelink carrier and one or more complementary sidelink carriers, and transmitting sidelink configuration information of the one or more complementary sidelink carriers on the primary sidelink carrier based on the association relationship.

According to a second aspect of the present disclosure, there is provided a method for receiving sidelink configuration in V2X communication. The method is performed at the terminal device and may include obtaining association relationship between a primary sidelink carrier carrying sidelink configuration information of the primary sidelink carrier and one or more complementary sidelink carriers; and receiving sidelink configuration information of the one or more complementary sidelink carriers on the primary sidelink carrier based on the association relationship.

According to a third aspect of the present disclosure, there is provided a terminal device. The terminal device may comprise at least one processor and at least one memory coupled with the at least one processor. The at least one memory has computer program codes stored therein which are configured to, when executed on the at least one processor, cause the terminal device to perform operations of the first aspect.

According to a fourth aspect of the present disclosure, there is provided another terminal device. The other terminal device may comprise at least one processor and at least one memory coupled with the at least one processor. The at least one memory has computer program codes stored therein which are configured to, when executed on the at least one processor, cause the terminal device to perform operations of the second aspect.

According to a fifth aspect of the present disclosure, there is provided a computer-readable storage medium having a computer program stored thereon which, when executed by at least one processor of a device, causes the device to perform actions in the method according to any embodiment in the first aspect.

According to a sixth aspect of the present disclosure, there is provided a computer-readable storage medium having a computer program stored thereon which, when executed by at least one processor of a device, causes the device to perform actions in the method according to any embodiment in the second aspect.

According to a seventh aspect of the present disclosure, there is provided a computer program product comprising a computer-readable storage medium according to the fifth aspect.

According to an eighth aspect of the present disclosure, there is provided a computer program product comprising a computer-readable storage medium according to the sixth aspect.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIGS. 1A and 1B respectively illustrate signaling charts of synchronization information transmission for sidelink communication or V2X sidelink communication, in (partial) coverage and out of coverage;

FIG. 2 schematically illustrates triggering conditions for synchronization information transmission in LTE-V2X communication;

FIG. 3 schematically illustrates contents contained within a physical sidelink broadcast channel (PSBCH) in the LTE-V2X communication;

FIG. 4 schematically illustrates synchronization reference priority order in the LTE-V2X communication;

FIG. 5 schematically illustrates DMRS configuration for physical sidelink shared channel (PSSCH) and PSBCH in the LTE-V2X communication;

FIG. 6 schematically illustrates an example synchronization scenario in which embodiments of the present disclosure can be implemented;

FIG. 7 schematically illustrates a flow chart of a method for sidelink configuration information transmission in V2X communication according to some embodiments of the present disclosure;

FIG. 8 schematically illustrates association relationship between a primary sidelink carrier carrying sidelink configuration information of the primary sidelink carrier and one or more complementary sidelink carriers according to some embodiments of the present disclosure;

FIG. 9 schematically illustrates an example scheme of transmission of sidelink configuration information of complementary sidelink carriers on the PSBCH according to some embodiments of the present disclosure;

FIG. 10 schematically illustrates another example scheme of transmission of sidelink configuration information of complementary sidelink carriers on the PSBCH according to some embodiments of the present disclosure;

FIG. 11 schematically illustrates a further example scheme of transmission of sidelink configuration information of complementary sidelink carriers on the PSBCH according to some embodiments of the present disclosure;

FIG. 12A schematically illustrates an example scheme of transmission for sidelink configuration information complementary sidelink carriers on PSSCH according to some embodiments of the present disclosure;

FIG. 12B schematically illustrates another example scheme of transmission for sidelink configuration information complementary sidelink carriers on PSSCH according to some embodiments of the present disclosure;

FIG. 13 schematically illustrates example triggering conditions for synchronization information transmission according to some embodiments of the present disclosure;

FIG. 14 schematically illustrates a flow chart of a method for sidelink configuration reception in V2X communication according to some embodiments of the present disclosure;

FIG. 15 schematically illustrates an example scheme for synchronization reference selection according to some embodiments of the present disclosure;

FIG. 16 schematically illustrates a block diagram of an apparatus for sidelink configuration transmission in V2X communication according to some embodiments of the present disclosure;

FIG. 17 schematically illustrates a block diagram of an apparatus for sidelink configuration reception in V2X communication according to some embodiments of the present disclosure;

FIG. 18 schematically illustrates a simplified block diagram of an apparatus 1810 that may be embodied as or comprised in a terminal device like UE, and an apparatus 1820 that may be embodied as or comprised in another terminal device like UE, as described herein.

### DETAILED DESCRIPTION OF EMBODIMENTS

Hereinafter, the solutions as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner. For example, features illustrated or described as part of one embodiment may be used with another embodiment to yield still a further embodiment. In the interest of clarity, not all features of an actual implementation are described in this specification.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “wireless communication network” refers to a network following any suitable wireless communication standards, such as New Radio (NR), Long Term Evolution (LTE), LTE-Advanced (LTE-A), Wideband Code Division Multiple Access (WCDMA), High-Speed Packet Access (HSPA), and so on. The “wireless communication network” may also be referred to as a “wireless communication system.” Furthermore, communications between network devices, between a network device and a terminal device, or between terminal devices in the wireless communication network may be performed according to any suitable communication protocol, including, but not limited to, Global System for Mobile Communications (GSM), Universal Mobile Telecommunications System (UMTS), Long Term Evolution (LTE), New Radio (NR), wireless local area network (WLAN) standards, such as the IEEE 802.11 standards, and/or any other appropriate wireless communication standard either currently known or to be developed in the future.

As used herein, the term “network device” refers to a node in a wireless communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communications. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “communication device”, “terminal”, “user equipment” and “UE” may be used interchangeably.

As yet another example, in an Internet of Things (TOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink (DL) transmission refers to a transmission from a network device to UE, and an uplink (UL) transmission refers to a transmission in an opposite direction.

Hereinafter, solutions regarding synchronization signal transmission in the LTE-V2X communication will be first described only for illustrative purposes.

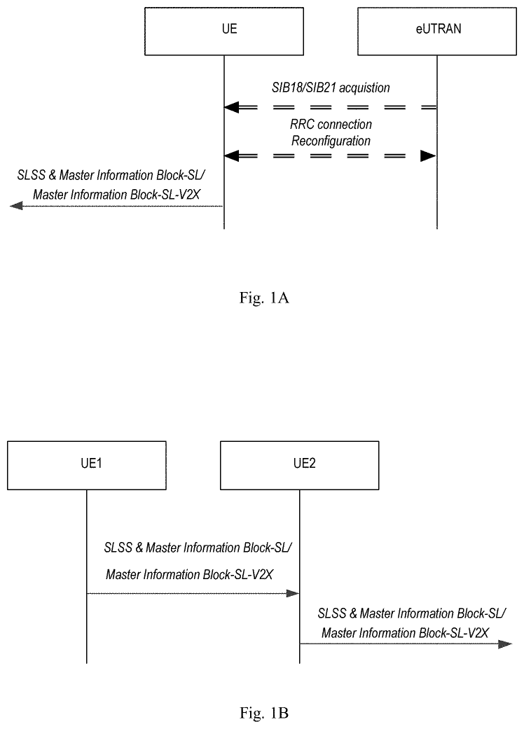

FIGS. 1A and 1B schematically illustrate signaling charts of synchronization information transmission for sidelink communication or V2X sidelink communication, in (partial) coverage and out of coverage. As illustrated in FIG. 1A, if UE is in coverage of the communication network like Evolved Universal Terrestrial Radio Access (Network), the UE transmits synchronization information including sidelink synchronization signal (SLSS) and Master Information Block-SL/Master Information Block-SL-V2X, when the eUTRAN configures the UE to do so by a dedicated signaling like an RRC signaling or based on SIB 18/SIB 21 acquisition broadcast by the eUTRAN. As illustrated in FIG. 1B, as for an out-of-coverage case, wherein the UE is not covered by the eUTRAN, the UE performs synchronization information transmission based on a pre-configured synchronization information transmission threshold and transmits the synchronization information including SLSS and Master Information Block-SL/Master Information Block-SL-V2X when the channel quality measurement is lower than the information transmission threshold.

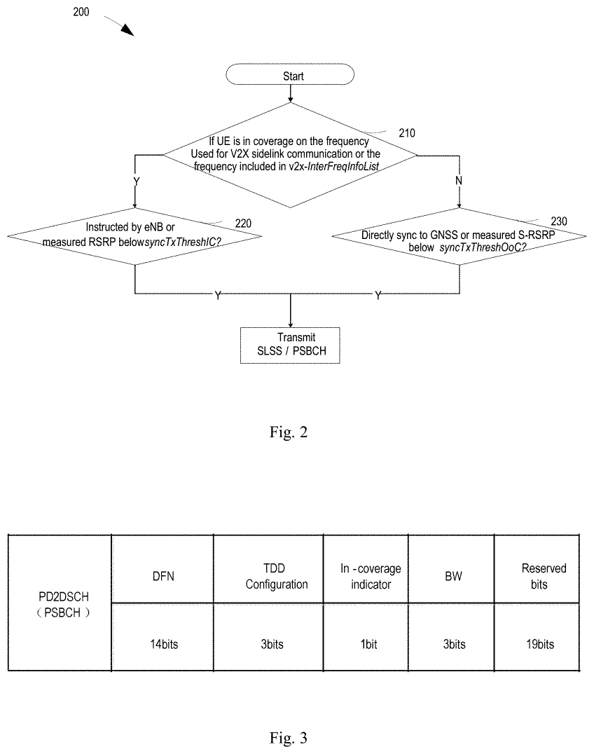

FIG. 2 illustrates example triggering conditions for synchronization information transmission in the LTE system. As illustrated in FIG. 2, in step 210, UE determines whether the UE is in coverage on the frequency used for V2X sidelink communication or the frequency included in v2x-InterFreqInfoList. If yes, the method 200 proceeds with step 220 and if no, the method proceeds with step 230. In step 220, the UE further determines whether it is instructed by eNB to transmit the synchronization information or whether the measured RSRP is below an in-coverage synchronization transmission threshold SynTxThredhIC; if yes, the UE transmits the synchronization information SLSS/PSBCH. If the UE is out of the coverage, in step 230, the UE further determines if it is directly synchronized to GNSS, or the measured RSRP is below an out-of-coverage synchronization transmission threshold SynTxThredhOC; if yes, the UE transmits the synchronization information SLSS/PSBCH.

The physical sidelink broadcast channel PSBCH is a physical broadcast channel for sidelinks and can be used to carry sidelink configuration information. FIG. 3 illustrates a diagram of contents contained within a physical sidelink broadcast channel in the LTE-V2X communication. As illustrated in FIG. 3, these contents include a Direct frame number (DFN), Time Division Duplex (TDD) configuration, in-coverage indicator, sidelink system bandwidth indication. The DFN indicates the number of the frame (14 bits), the TDD configuration indicates the UL-DL configuration (3bits), the in-coverage indicator indicates whether the UE is in coverage (1 bit) and the sidelink system bandwidth indication indicates the system bandwidth of the sidelink (3 bits). In addition, there are 19 reserved bits.

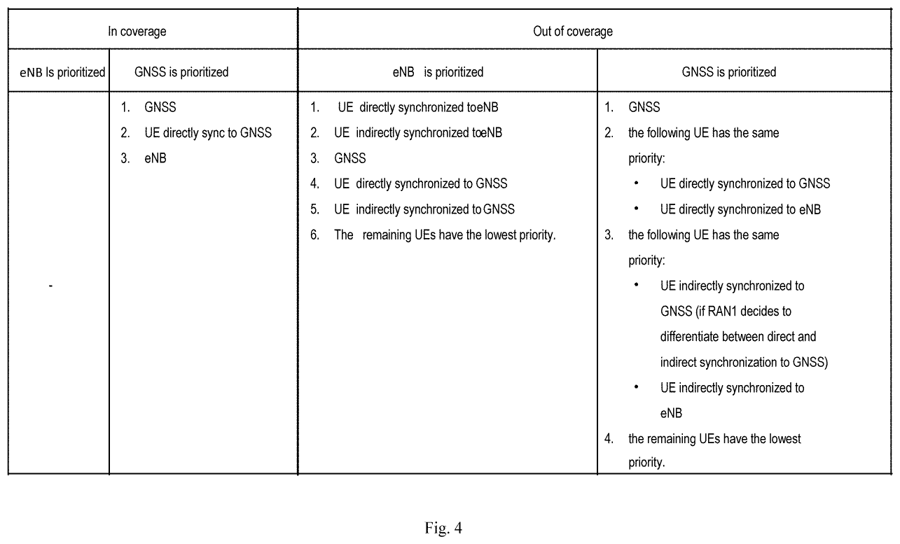

The SLSS is sidelink synchronization signal and in some cases, the UE may detect sidelink synchronization signals from more than one synchronization references. In such cases, the UE may select a synchronization reference based on a predetermined synchronization reference priority order. For illustrative purposes, FIG. 4 illustrates synchronization reference priority order in the LTE-V2X communication. As illustrated in FIG. 4, if the UE is in coverage of eNB, the eNB will be selected as the synchronization reference if eNB is prioritized; on the other hand, if the GNSS is prioritized, the priority order can follow GNSS, UE directly synchronized to GNSS and the eNB. If the UE is out of coverage of the eNB, there are two prioritization scheme, i.e., the first scheme in which the eNB is prioritized and the second scheme in which the GNSS is prioritized. For the first scheme, the priority order may follow UE directly synchronized to eNB, UE indirectly synchronized to eNB, GNSS, UE directly synchronized to GNSS, UE indirectly synchronized to GNSS, and remaining UE (with the lowest priority). For the second scheme, the priority order may follow GNSS, UE directly synchronized to eNB or GNSS, UE indirectly synchronized to eNB or GNSS, and remaining UE (with the lowest priority).

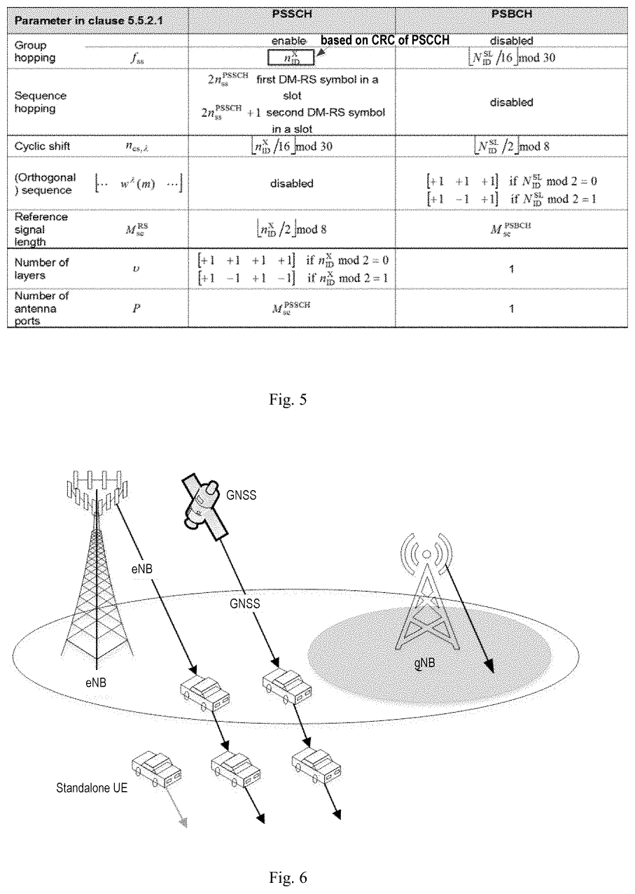

In sidelink communication, a demodulation reference signal (DMRS) is used as a reference signal for demodulation of physical sidelink shared channel (PSSCH) and physical sidelink broadcast channel (PSBCH). For PSSCH, the DMRS is generated based on n^{X}_{ID} which is a value of Cyclic Redundancy Check (CRC) of physical sidelink control channel (PSCCH), and for PSBCH, the DMRS is generated based on n^{SL}_{ID} which is an identity of the sidelink synchronization signal (SLSS). For illustrative purposes, FIG. 5 schematically illustrates DMRS configuration for PSSCH and PSBCH in the LTE-V2X communication.

As mentioned hereinabove, in 3GPP RNA #80 meeting, an SI was already approved with a target to support advanced V2X use cases defined 3GGP TR 22.886, and the NR V2X is supposed to complement LTE V2X instead of replacing it. FIG. 6 illustrates an example synchronization scenario in NR V2X communication. As illustrated in FIG. 5, there are five vehicles as UE0, UE1, UE2, UE3 and UE4, wherein UE0 and UE1 are synchronized to the eNB, UE 2 and UE 3 are synchronized to the GNSS, and UE 4 is a standalone UE which is not synchronized to any of synchronization sources. In addition, there is also a new synchronization reference gNB to complement the LTE V2X. For the V2X technology, to adapt to the new synchronization scenario, there are several aspects to be studied including sidelink design, Uu enhancements for advanced V2X use cases, Uu-based sidelink resource allocation/configuration, Radio Access Technology (RAT)/Interface selection for operation, QoS management, and coexistence. Amongst others, it is still a problem about how to implement synchronization on NR sidelink under the new synchronization scenario.

Embodiments of the present disclosure present a solution for sidelink configuration transmission and reception in V2X communication. In some embodiments of the present disclosure, it is proposed to transmit synchronization information for one or more sidelink carrier (for example the NR sidelink carrier) on the primary sidelink carrier (for example the LTE sidelink carrier). Thus, the UE may first obtain association relationship between a primary sidelink carrier carrying sidelink configuration information of the primary sidelink carrier and one or more complementary sidelink carriers, and then transmit sidelink configuration information of the one or more complementary sidelink carriers based on the association relationship. Thus, the synchronization mechanism for the LTE V2X communication can be reused as much as possible and the sync performance on the NR sidelink may be improved since usually, the eNB could provide a larger coverage than gNB. In addition, the UE has no need to transmit LTE SLSS/PSBCH and NR SLSS/PSBCH simultaneously, which means reduced overhead of SLSS/PSBCH transmission.

Hereinafter, reference will be further made to accompanying drawings to describe the solutions as proposed in the present disclosure in details. However, it shall be appreciated that the following embodiments are given only for illustrative purposes and the present disclosure is not limited thereto.

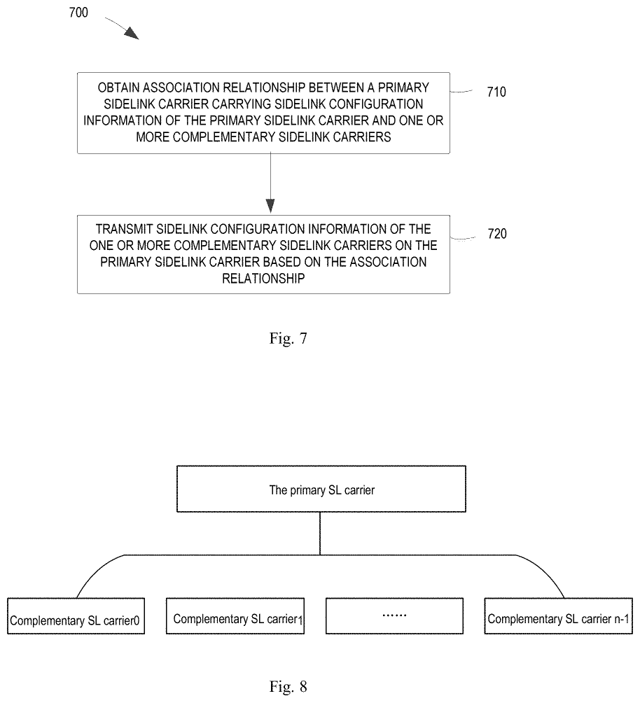

FIG. 7 schematically illustrates a flow chart of a method for sidelink configuration transmission in V2X communication according to some embodiments of the present disclosure. The method 700 can be implemented at a terminal device like UE or any other terminal device involved in V2X communication.

As illustrated in FIG. 7, first in step 710, the terminal device may obtain association relationship between a primary sidelink carrier carrying sidelink configuration information of the primary sidelink carrier and one or more complementary sidelink carriers.

The primary sidelink carrier may be for example LTE sidelink carrier, which can be used to carry synchronization information including SLSS and PSBCH and the complementary sidelink carrier may be NR sidelink carrier. The SLSS may include the primary sidelink synchronization signal (PSSS) and the secondary sidelink synchronization signal (SSSS). The PSBCH may be used to carry sidelink configuration information of the primary sidelink carrier, which may contain DFN, TDD configuration, in-coverage indicator, sidelink system bandwidth indication, etc.

As mentioned, the NR V2X is supposed to complement LTE V2X instead of replacing it, which means NR sidelink is always accompanied by LTE sidelink. Thus, in embodiments of the present disclosure, it is proposed to transmit synchronization information for NR V2X on the primary sidelink carrier and the association relationship is used to indicate the complementary sidelink carriers and the primary sidelink carrier on which the sidelink configuration information of the complementary sidelink carriers is to be transmitted. In other words, the sidelink configuration information of the one or more complementary sidelink carrier will be transmitted together with sidelink configuration information of the primary sidelink carriers on the primary sidelink carrier.

For illustrative purposes, FIG. 8 schematically illustrates association relationship between the primary sidelink carrier and one or more complementary sidelink carriers according to some embodiments of the present disclosure. As illustrated in FIG. 8, a primary sidelink carrier is associated with n complementary sidelink carrier, which means sidelink configuration information of n complementary sidelink carriers will be transmitted on the primary side carrier together with those of the primary sidelink carrier.

In some embodiments of the present disclosure, the association relationship can be configured by a network device like eNB or gNB. It can be configured by a Radio Resource Control signaling, Media Access Control-Control Element (MAC-CE), or physical layer signaling. For example, it may contain an identity of the primary sidelink carrier and a list of complementary sidelink carriers. In addition, in some embodiments of the present disclosure, the association relationship may be a pre-configured association relationship.

Next, in step 720, the terminal device transmits sidelink configuration information of the one or more complementary sidelink carriers on the primary sidelink carrier based on the association relationship. Based on the association relationship, the UE could learn the complementary sidelink carriers and the primary sidelink carrier used to transmit the sidelink configuration information of the complementary sidelink carrier. Based on the information, the terminal device could transmit the configuration information of the complementary sidelink carrier on the primary sidelink carrier.

The sidelink configuration information of the complementary sidelink carriers includes at least one of: bandwidth, subcarrier spacing, bandwidth part configuration, slot configuration, frame number offset with respect to the LTE sidelink carrier, and etc.

In some embodiments of the present disclosure, reserved bits in PSBCH can be used to transmit the sidelink configuration information of the complementary sidelink carriers. As illustrated in FIG. 3, the PSBCH has 19 reserved bits which can thus be used to transmit sidelink configuration information of the complementary sidelink carriers.

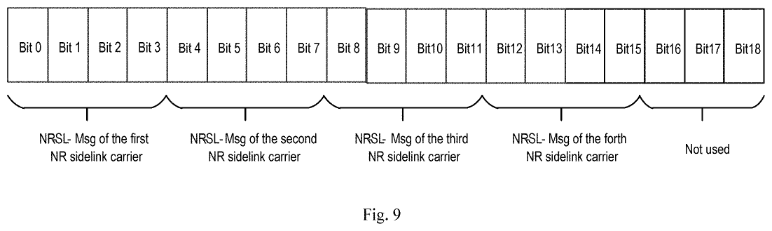

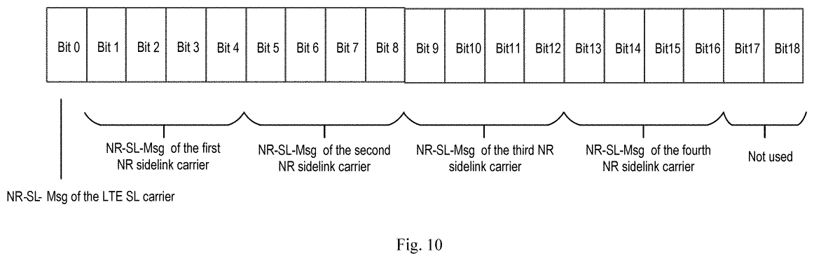

FIG. 9 schematically illustrates an example scheme of transmission of sidelink configuration information of complementary sidelink carriers on the PSBCH according to some embodiments of the present disclosure. The sidelink configuration information (NR-SL-Msg) for the i^{th} associated complementary sidelink carrier can be transmitted with bit i*n to bit i*n+n−1 of 19 reserved bits in exiting PSBCH, wherein n denotes the number of bits needed for one NR sidelink carrier, and the value of n is specified. In FIG. 9, an example with n=4 is illustrated, wherein each NR-SL-Msg of the first to fourth occupies 4bits, which means each of the complementary sidelink uses the same number of bits to transmit its sidelink configuration.

In some embodiments of the present disclosure, the primary sidelink carrier can be associated with itself, and this means a complementary sidelink carrier sharing the same carrier with the primary sidelink carrier. In such a case, configuration information of the complementary sidelink carrier may occupy fewer bits than other complementary sidelink carriers since some configuration information of the shared sidelink carrier is already transmitted in configuration information of the primary sidelink carrier. For example, the UE may use n1 of reserved bit to transmit the sidelink configuration information on the primary sidelink carrier, and use M*n2 of reserved bits to transmit the sidelink configuration information of other complementary sidelink carriers, wherein n1 and n2 are specified values, and can be different from each other; M denotes the number of other complementary NR SL carriers (other than the shared sidelink carrier); M can be zero;

FIG. 10 schematically illustrates another example scheme of transmission of sidelink configuration information of complementary sidelink carriers on the PSBCH according to some embodiments of the present disclosure, wherein n1=1, n2=4 and M=4. It is clear From FIG. 10 that NR-SL-Msg of the primary SL carrier just use one bit which is less than NR-SL_Msgs for the first to the fourth complementary sidelink carriers.

In some embodiments of the present disclosure, it is also possible to use more than one PSBCH transmission to indicate configurations of K complementary sidelink carriers. Thus, in each of PSBCH, it may use x bits to indicate the index of the complementary sidelink, with x=ceil(log 2(K) and use n bits to indicate configuration of complementary sidelink carriers to be transmitted on the primary sidelink carrier, wherein K indicates the total number of the complementary sidelink carriers. One PSBCH can only indicate configuration of m NR sidelink carriers, wherein m≤K.

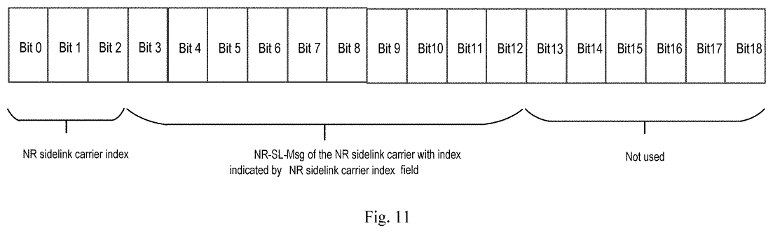

FIG. 11 schematically illustrates a further example scheme of transmission of sidelink configuration information of complementary sidelink carriers on the PSBCH according to some embodiments of the present disclosure, wherein x=3, n=10, and m=1. As illustrated in FIG. 11, the first three bits are “NR sidelink carrier index” field for indicating the indices of NR sidelink carriers and the following ten bits are configuration information bits used to indicate sidelink configuration information of the NR sidelink carriers with index indicated by the first three bits (“NR sidelink carrier index” filed).

In some embodiments of the present disclosure, the sidelink configuration information of the one or more complementary sidelink carrier might be transmitted on a sidelink data channel of the primary sidelink carrier. The sidelink data channel is located within the same subframe as a physical sidelink broadcast channel carrying the sidelink configuration information of the primary sidelink carrier and a sidelink synchronization signal, and is adjacent thereto in a frequency domain. With such arrangement of sidelink data channel, it is possible to reduce overhead of the terminal device, and also reduce peak-to-average power ratio (PAPR).

In some embodiments of the present disclosure, a physical sidelink shared channel (PSSCH) is used to transmit configuration information for NR sidelink carrier NR-SL-Msg, which can be called as NR-SL-Msg PSSCH. The NR-SL-Msg PSSCH and SLSS/PSBCH are always transmitted in the same subframe; and the resource for the NR-SL-Msg PSSCH consists of consecutive PRBs, and also adjacent to resources for SLSS/PSBCH transmission in frequency domain.

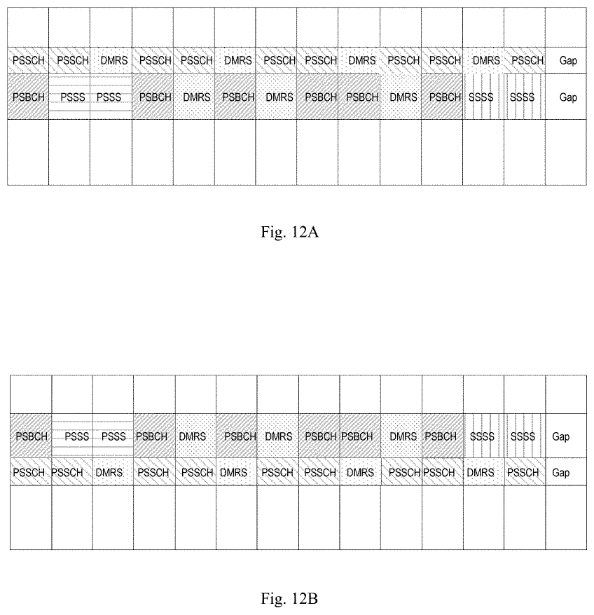

FIGS. 12A and 12B schematically illustrate two example scheme of transmission for sidelink configuration information of complementary sidelink carriers on PSSCH according to some embodiments of the present disclosure. As illustrated in FIG. 12A, the PSSCH for configuration information for NR sidelink carrier consists of consecutive PRBs and it is located adjacent to PBSCH/SLSS in frequency domain and has a higher frequency than PBSCH/SLSS. Different from FIG. 12A, in FIG. 12B, the PSSCH for configuration information for NR sidelink carrier has a lower frequency than PBSCH/SLSS.

From FIGS. 12A and 12B, it can be seen that there is no control channel for the PSSCH. Due to lack control channel for the PSSCH, MCS of the PSSCH might become an issue. Thus, in some embodiments of the present disclosure, there is proposed to use the same MCS as the PSBCH. In other words, the PSSCH can be modulated and coded with the same MCS as the PBSCH.

Besides, in order to demodulate the PSSCH, demodulation reference signals are required to transmit together with PSSCH. In the LTE-V2X, DMRS for PSSCH is generated based on the decimal representation of Cyclic Redundancy Check (CRC) of PSCCH as illustrated in FIG. 5; however, due to lack of control channel for PSSCH, the DMRS generation will be a problem. Thus, in some embodiments of the present disclosure, decimal representation of the PSBCH CRC can be used to generate the DMRS. Alternatively, an identity of the sidelink synchronization signal can be used to generate the DMRS as well.

In addition, it may consider performing a pre-Discrete Fourier Transformation on the sidelink data channel independently from the physical sidelink broadcast channel. By this way, the PSBCH and the PSSCH can be decoded separately.

In another aspect of the present disclosure, it is further proposed a synchronization information transmission triggering solution. In some embodiments of the present disclosure, the synchronization information transmission is triggered based on at least one of control of a network device providing a synchronization reference and another network device providing an additional synchronization reference and synchronization signal transmission thresholds respectively related to the network device and the other network device. Thus, the triggering conditions for the synchronization information transmission contains not only control of eNB and synchronization signal transmission thresholds related to eNB, but also control of gNB and synchronization signal transmission thresholds related to the gNB.

In some embodiments of the present disclosure, for in coverage UE capable of synchronization information transmission, it shall transmit SLSS/PSBCH when at least the following conditions are satisfied:
eNB/gNB instructed the UE to transmit SLSS/PSBCH, or,
eNB/gNB does not instructed the UE stop SLSS/PSBCH transmission, and,
   one or both of e-UTRA Reference signal received power (eUTRA-RSRP) threshold T_{eUTRAN} and Synchronization Signal Reference Signal Received Power (SS-RSRP) threshold T_{SS} are configured, and,
   if synchronization information transmission threshold T_{eUTRAN} related to eNB is configured, the measured eUTRA-RSRP of the synchronization reference eNB is lower than T_{eTRAN}, and,
   if synchronization information transmission threshold T_{SS} related to gNB is configured, the measured SS-RSRP of the sync reference gNB is lower than T_{SS}.

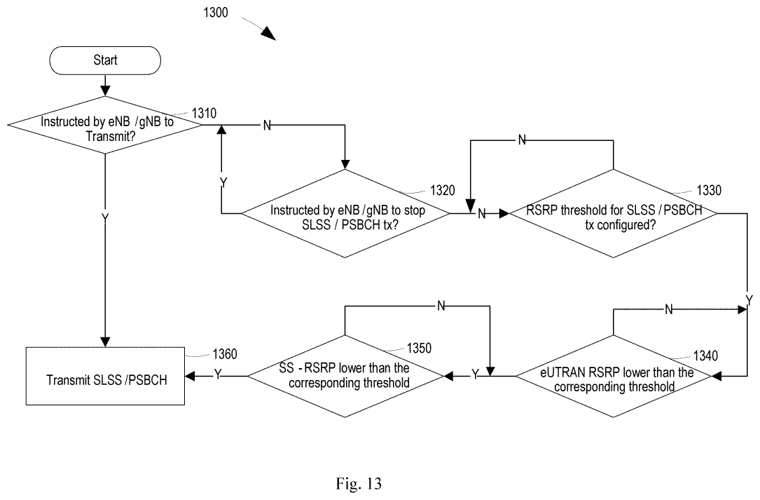

For illustrative purposes, FIG. 13 schematically illustrates example triggering conditions for synchronization information transmission according to some embodiments of the present disclosure. As illustrated in FIG. 13, first in step 1310, the UE determines whether it is instructed to transmit synchronization information. If yes, the method goes to step 1360 in which the UE transmits SLSS and PSBCH; if no, the method goes to step 1320. In step 1320, the UE further determines whether it is instructed by eNB or gNB to stop SLSS/PSBCH transmission. If yes, the method waits until the result of determination is no in step 1320; if no, the method proceeds with step 1330. In step 1330, the UE further determines whether the RSRP thresholds for SLSS/PSBCH transmission is configured; if yes, the method goes to step 1340 and if no, the method waits until the result of determination is yes in step 1330. In step 1340, the UE determines whether the measured eUTRAN RSRP related to eNB is lower than its corresponding threshold; if yes, the method goes to step 1350 and if no, the method waits until the result of determination in step 1340 is yes. In step 1350, the UE further determines whether SS-RSRS related to the gNB is lower than its corresponding threshold. If yes, the method proceeds with step 1360 in which the UE transmit SLSS and PSBCH; if no, the method waits until the result of determination in step 1350 is yes.

It shall be noticed that for the embodiments in which the sidelink data channel is used to carry sidelink configuration information of the complementary sidelink carrier, the sidelink data channel shall also be transmitted together with the SLSS and PSBCH.

FIG. 14 schematically illustrates a flow chart of a method for sidelink configuration reception in V2X communication according to some embodiments of the present disclosure. The method 1400 can be performed as the terminal device, like UE or any other terminal devices.

As illustrated in FIG. 14, the method starts from step 1410, in which the terminal device may obtain association relationship between a primary sidelink carrier carrying sidelink configuration information of the primary sidelink carrier and one or more complementary sidelink carriers.

The primary sidelink carrier may be for example LTE sidelink carrier, which can be used to carry synchronization information including SLSS and PSBCH and the complementary sidelink carrier may be NR sidelink carrier. The SLSS may include PSSS and SSSS. The PSBCH may be used to carry sidelink configuration information of the primary sidelink carrier, which may contain DFN, TDD configuration, in-coverage indicator, sidelink system bandwidth indication, etc.

The association relationship is used to indicate the complementary sidelink carrier and the primary sidelink carrier on which the sidelink configuration information of the complementary sidelink carrier is to be transmitted. In some embodiments of the present disclosure, the association relationship may be obtained from any of pre-configured association information. In some embodiments of the present disclosure, the association relationship may be obtained from association configuration information received from a network device.

In some embodiments of the present disclosure, the association relationship can be configured by a network device like eNB or gNB. It can be configured through a Radio Resource Control signaling, Media Access Control-Control Element (MAC-CE), or physical layer signaling. For example, the association configuration information may contain an identity of the primary sidelink carrier and a list of complementary sidelink carriers. In addition, in some embodiments of the present disclosure, the association relationship may be a pre-configured association relationship.

Next, in step 1420, the terminal device receives sidelink configuration information of the one or more complementary sidelink carriers on the primary sidelink carrier based on the association relationship. Based on the association relationship, the UE could learn the complementary sidelink carrier and the primary sidelink carrier used to transmit the sidelink configuration information of the complementary sidelink carrier. Based on the information, the terminal device could receive the configuration information of the complementary sidelink carrier on the primary sidelink carrier.

The sidelink configuration information of the complementary sidelink carriers includes at least one of: bandwidth, subcarrier spacing, bandwidth part configuration, slot configuration, frame number offset with respect to the LTE sidelink carrier, and etc.

In some embodiments of the present disclosure, the terminal device may receive the sidelink configuration information of the one or more complementary sidelink carriers in reserved bits of a physical sidelink broadcast channel carrying the sidelink configuration information of the primary sidelink carrier on the primary sidelink carrier.

In some embodiments of the present disclosure, the sidelink configuration information of each of the one or more complementary sidelink carriers may occupy the same number of bits.

In some embodiments of the present disclosure, the configuration information of a complementary sidelink carrier sharing the same carrier with the primary sidelink carrier may occupy fewer bits than other complementary sidelink carriers.

In some embodiments of the present disclosure, the terminal device may receive the sidelink configuration information of the one or more complementary sidelink carrier on a sidelink data channel of the primary sidelink carrier. The sidelink data channel may be located within the same subframe as PSBCH carrying the sidelink configuration information of the primary sidelink carrier and SLSS, and is adjacent thereto in a frequency domain.

In some embodiments of the present disclosure, the sidelink data channel may be demodulated and decoded based on a same modulation and coding scheme as the physical sidelink broadcast channel.

In some embodiments of the present disclosure, the terminal device may perform a channel estimation based on a received demodulation reference signal sequence for the sidelink data channel and any of a value of Cyclic Redundancy Check (CRC) of the physical sidelink broadcast channel and an identity of the sidelink synchronization signal.

In addition, in a further aspect of the present disclosure, there is further provided a synchronization reference selection solution. In the new V2X scenario like as illustrated in FIG. 6, an additional synchronization reference gNB is further introduced and thus a new synchronization reference selection solution is required. To this end, in some embodiments of the present disclosure, the terminal device selects, in response to detection of synchronization signals from a network device providing a synchronization reference and another network device providing an additional synchronization reference, one of the synchronization references based on at least one of: a pre-defined priority for the network device and the other network device, and channel quality measurements for the network device and the other network device.

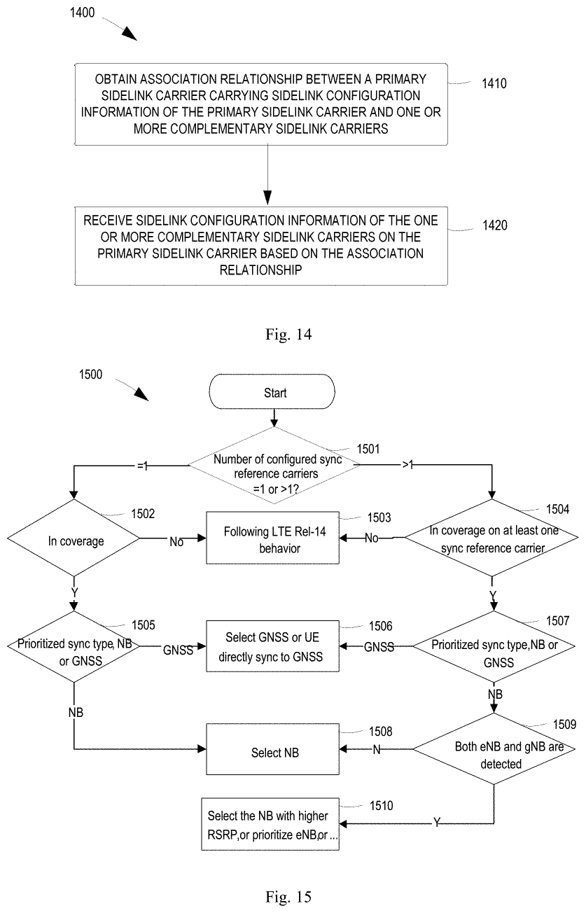

For illustrative purposes, FIG. 15 schematically illustrates an example scheme for synchronization reference selection according to some embodiments of the present disclosure. As illustrated in FIG. 15, in step 1501 the UE first determines whether the number of synchronization reference carriers is one or larger than one. If it is one, then in step 1502, the UE further determines whether it is in coverage, if so, the method 1500 goes into step 1505, else the method goes into step 1503. In step 1503, the synchronization reference selection can follow the LTE Rel-14 behavior like those illustrated in FIG. 2. In step 1505, the UE determines whether the synchronization priority type is NB being prioritized or GNSS being prioritized. If it is GNSS being prioritized, GNSS or UE directly synchronized to GNSS is selected as the synchronization reference in step 1506; if it is NB being prioritized, NB is selected as the synchronization reference in step 1508.

If the number of synchronization reference carriers is larger than one, the method goes to step 1504 in which the UE further determines whether there is at least one synchronization reference carrier in coverage; if no, the method goes to step 1503 in which the synchronization reference selection can follow the LTE Rel-14 behavior like those illustrated in FIG. 2 and if yes, the method proceeds with step 1507 in which the UE further determines whether the synchronization priority type is NB being prioritized or GNSS being prioritized. If it is GNSS being prioritized, GNSS or UE directly synchronized to GNSS is selected as the synchronization reference in step 1506; if it is NB being prioritized, the UE further determines whether both eNB and gNB are detected; if no, the detected NB is selected in step 1508, and if yes, the NB with higher RSRP is selected, or alternatively eNB is always selected. For example, the gNB can be selected as the synchronization reference when SS-RSRP>E-UTRA-RSRP+Δ, wherein the parameter can be configured by a severing cell, such as eNB or gNB.

Hereinabove, the solutions of the present disclosure performed at the terminal device receiving synchronization information are described with reference to FIGS. 14 and 15. Most of the operations of the terminal device receiving synchronization information are corresponding to those of the terminal device transmitting synchronization information. Thus, for some details of operations at the terminal device receiving synchronization information, one may refer to description with reference to FIGS. 7 to 13.

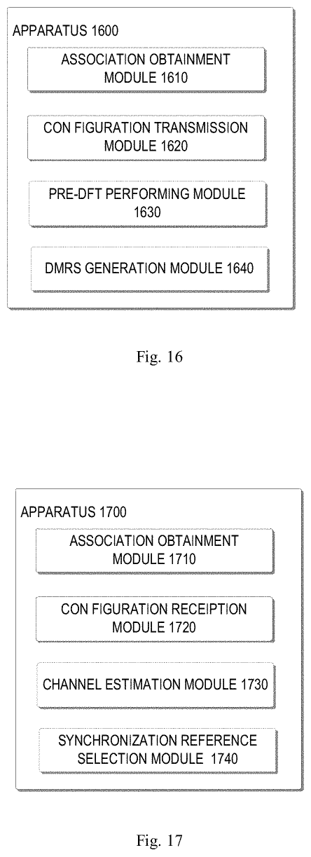

FIG. 16 schematically illustrates a block diagram of an apparatus for sidelink configuration transmission in V2X communication according to some embodiments of the present disclosure. The apparatus 1600 can be implemented at a terminal device involved in V2X communication.

As illustrated in FIG. 16, the apparatus 1600 may comprise an association obtainment module 1610 and a configuration transmission module 1620. The association obtainment module 1610 may be configured to obtain association relationship between a primary sidelink carrier carrying sidelink configuration information of the primary sidelink carrier and one or more complementary sidelink carriers. The configuration transmission module 1620 may be configured to transmit sidelink configuration information of the one or more complementary sidelink carriers on the primary sidelink carrier based on the association relationship.

In some embodiments of the present disclosure, the association obtainment module 1610 may be configured to obtain the association relationship from pre-configured association information. Alternatively, the association obtainment module 1610 may be configured to obtain the association relationship from association configuration information received from a network device.

In some embodiments of the present disclosure, the configuration transmission module 1620 may be configured to transmit the sidelink configuration information of the one or more complementary sidelink carriers in reserved bits of a physical sidelink broadcast channel carrying the sidelink configuration information of the primary sidelink carrier on the primary sidelink carrier.

In some embodiments of the present disclosure, the sidelink configuration information of each of the one or more complementary sidelink carriers may occupy the same number of bits.

In some embodiments of the present disclosure, the configuration information of a complementary sidelink carrier sharing the same carrier with the primary sidelink carrier may occupy fewer bits than other complementary sidelink carriers.

In some embodiments of the present disclosure, the configuration transmission module 1620 may be configured to transmit the sidelink configuration information of the one or more complementary sidelink carrier on a sidelink data channel of the primary sidelink carrier. The sidelink data channel, may be located within the same subframe as a physical sidelink broadcast channel carrying the sidelink configuration information of the primary sidelink carrier and a sidelink synchronization signal, and may be adjacent thereto in a frequency domain.

In some embodiments of the present disclosure, the sidelink data channel may be modulated and coded based on a same modulation and coding scheme as the physical sidelink broadcast channel.

In some embodiments of the present disclosure, the apparatus may further comprise a pre-DFT performance module 1630 configured to perform a pre-Discrete Fourier Transformation on the sidelink data channel independently from the physical sidelink broadcast channel.

In some embodiments of the present disclosure, the apparatus may further comprise a DMRS generation module 1640 configured to generate a demodulation reference signal sequence for the sidelink data channel based on any of: a value of Cyclic Redundancy Check (CRC) of the physical sidelink broadcast channel and an identity of the sidelink synchronization signal.

In some embodiments of the present disclosure, transmission of the sidelink configuration information of the one or more primary sidelink carrier and the sidelink configuration information of the one or more complementary sidelink carrier are triggered based on at least one of control of a network device providing a synchronization reference and another network device providing an additional synchronization reference; and synchronization signal transmission thresholds respectively related to the network device and the other network device.

In some embodiments of the present disclosure, the one or more complementary sidelink carriers are new radio sidelink carriers and the primary sidelink carrier is a long term evolution sidelink carrier.

FIG. 17 schematically illustrates a block diagram of an apparatus for sidelink configuration reception in V2X communication according to some embodiments of the present disclosure. The apparatus 1700 can be implemented at a terminal device involved in V2X communication.

As illustrated in FIG. 17, the apparatus 1700 comprises an association obtainment module 1710 and a configuration reception module 1720. The association obtainment module 1710 may be configured to obtain association relationship between a primary sidelink carrier for carrying sidelink configuration information of the primary sidelink carrier and one or more complementary sidelink carriers. The configuration reception module 1720 may be configured to receive sidelink configuration information of the one or more complementary sidelink carriers on the primary sidelink carrier based on the association relationship.

In some embodiments of the present disclosure, the association obtainment module 1710 may be configured to obtain association relationship from any of pre-configured association information. Alternatively, the association obtainment module 1710 may be configured to obtain association relationship from association configuration information received from a network device.

In some embodiments of the present disclosure, the configuration reception module 1720 may be configured to receive the sidelink configuration information of the one or more complementary sidelink carriers in reserved bits of a physical sidelink broadcast channel carrying the sidelink configuration information of the primary sidelink carrier on the primary sidelink carrier.

In some embodiments of the present disclosure, the sidelink configuration information of each of the one or more complementary sidelink carriers may occupy the same number of bits.

In some embodiments of the present disclosure, the configuration information of a complementary sidelink carrier sharing the same carrier with the primary sidelink carrier may occupy fewer bits than other complementary sidelink carriers.

In some embodiments of the present disclosure, the configuration reception module 1720 may be configured to receive the sidelink configuration information of the one or more complementary sidelink carrier on a sidelink data channel of the primary sidelink carrier. The sidelink data channel may be located within the same subframe as a physical sidelink broadcast channel carrying the sidelink configuration information of the primary sidelink carrier and a synchronization signal, and may be adjacent thereto in a frequency domain.

In some embodiments of the present disclosure, the sidelink data channel may be demodulated and decoded based on a same modulation and coding scheme as the physical sidelink broadcast channel.

In some embodiments of the present disclosure, the apparatus 1700 further comprise a channel estimation module 1730. The channel estimation module 1730 is configured to perform a channel estimation based on a received demodulation reference signal sequence for the sidelink data channel and any of a value of Cyclic Redundancy Check (CRC) of the physical sidelink broadcast channel and an identity of the sidelink synchronization signal.

In some embodiments of the present disclosure, the apparatus 1700 further comprise a synchronization reference selection module 1740. The synchronization reference selection module 1740 is configured to select, in response to detection of synchronization signals from a network device providing a synchronization reference and another network device providing an additional synchronization reference, one of the synchronization references based on at least one of: a pre-defined priority for the network device and the other network device, and channel quality measurements for the network device and the other network device.

In some embodiments of the present disclosure, the one or more complementary sidelink carriers are new radio sidelink carriers and the primary sidelink carrier is a long term evolution sidelink carrier.

Hereinabove, apparatuses 1600 to 1700 are described with reference to FIGS. 16 to 17 in brief. It can be noticed that the apparatuses 1600 to 1700 may be configured to implement functionalities as described with reference to FIGS. 7 to 15. Therefore, for details about the operations of modules in these apparatuses, one may refer to those descriptions made with respect to the respective steps of the methods with reference to FIGS. 7 to 15.

It is further noticed that components of the apparatuses 1600 to 1700 may be embodied in hardware, software, firmware, and/or any combination thereof. For example, the components of apparatuses 1600 to 1700 may be respectively implemented by a circuit, a processor or any other appropriate selection device.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, apparatuses 1600 to 1700 may include at least one processor. The at least one processor suitable for use with embodiments of the present disclosure may include, by way of example, both general and special purpose processors already known or developed in the future. Apparatuses 1600 to 1700 may further include at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause apparatuses 1600 to 1700 to at least perform operations according to the method as discussed with reference to FIGS. 7 to 15 respectively.

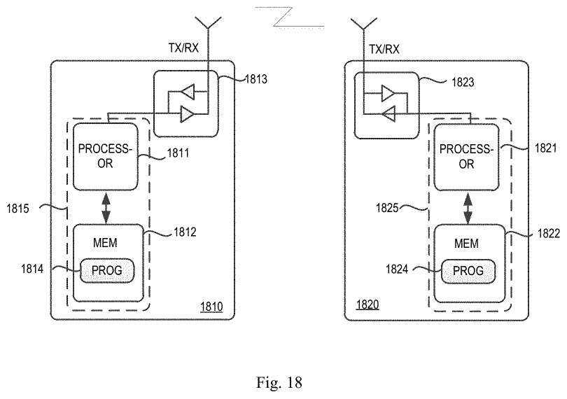

FIG. 18 schematically illustrates a simplified block diagram of an apparatus 1810 that may be embodied as or comprised in a terminal device like UE, and an apparatus 1820 that may be embodied as or comprised in another terminal device like UE as described herein.

The apparatus 1810 comprises at least one processor 1811, such as a data processor (DP) and at least one memory (MEM) 1812 coupled to the processor 1811. The apparatus 1810 may further include a transmitter TX and receiver RX 1813 coupled to the processor 1811, which may be operable to communicatively connect to the apparatus 1820. The MEM 1812 stores a program (PROG) 1814. The PROG 1814 may include instructions that, when executed on the associated processor 1811, enable the apparatus 1810 to operate in accordance with embodiments of the present disclosure, for example methods 700. A combination of the at least one processor 1811 and the at least one MEM 1812 may form processing means 1815 adapted to implement various embodiments of the present disclosure.

The apparatus 1820 comprises at least one processor 1821, such as a DP, and at least one MEM 1822 coupled to the processor 1821. The apparatus 1820 may further include a suitable TX/RX 1823 coupled to the processor 1821, which may be operable for wireless communication with the apparatus 1810. The MEM 1822 stores a PROG 1824. The PROG 1824 may include instructions that, when executed on the associated processor 1821, enable the apparatus 1820 to operate in accordance with the embodiments of the present disclosure, for example method 1400. A combination of the at least one processor 1821 and the at least one MEM 1822 may form processing means 1825 adapted to implement various embodiments of the present disclosure.

Various embodiments of the present disclosure may be implemented by computer program executable by one or more of the processors 1811, 1821, software, firmware, hardware or in a combination thereof.

The MEMs 1812 and 1822 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 1811 and 1821 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method for transmitting sidelink configuration in vehicle to everything (V2X) communication, comprising:
at a terminal device,
obtaining association relationship between a primary sidelink carrier carrying sidelink configuration information of the primary sidelink carrier and one or more complementary sidelink carriers; and
transmitting sidelink configuration information of the one or more complementary sidelink carriers on the primary sidelink carrier based on the association relationship.

2. The method of claim 1, wherein the association relationship is obtained from any of pre-configured association information and association configuration information received from a network device.

3. The method of claim 1, wherein the transmitting sidelink configuration information of the one or more complementary sidelink carriers on the primary sidelink carrier further comprises:
transmitting the sidelink configuration information of the one or more complementary sidelink carriers in reserved bits of a physical sidelink broadcast channel carrying the sidelink configuration information of the primary sidelink carrier on the primary sidelink carrier.

4. The method of claim 3, wherein the sidelink configuration information of each of the one or more complementary sidelink carriers occupies the same number of bits.

5. The method of claim 3, wherein the configuration information of a complementary sidelink carrier sharing the same carrier with the primary sidelink carrier occupies fewer bits than other complementary sidelink carriers.

6. The method of claim 1, wherein the transmitting sidelink configuration information of the one or more complementary sidelink carriers on the primary sidelink carrier comprises:
transmitting the sidelink configuration information of the one or more complementary sidelink carrier on a sidelink data channel of the primary sidelink carrier, the sidelink data channel being located within the same subframe as a physical sidelink broadcast channel carrying the sidelink configuration information of the primary sidelink carrier and a sidelink synchronization signal, and being adjacent thereto in a frequency domain.

7. The method of claim 6, wherein the sidelink data channel is modulated and coded based on a same modulation and coding scheme as the physical sidelink broadcast channel.

8. The method of claim 6, further comprising at least one of: performing a pre-Discrete Fourier Transformation on the sidelink data channel independently from the physical sidelink broadcast channel; or generating a demodulation reference signal sequence for the sidelink data channel based on any of: a value of Cyclic Redundancy Check (CRC) of the physical sidelink broadcast channel and an identity of the sidelink synchronization signal.

9. (canceled)

10. The method claim 1, wherein transmission of the sidelink configuration information of the one or more primary sidelink carrier and the sidelink configuration information of the one or more complementary sidelink carrier are triggered based on at least one of
control of a network device providing a synchronization reference and another network device providing an additional synchronization reference;
synchronization signal transmission thresholds respectively related to the network device and the other network device.

11. The method of claim 1, wherein the one or more complementary sidelink carriers are new radio sidelink carriers and the primary sidelink carrier is a long term evolution sidelink carrier.

12. A method for receiving sidelink configuration in vehicle to everything (V2X) communication, comprising:
at a terminal device,
obtaining association relationship between a primary sidelink carrier for carrying sidelink configuration information of the primary sidelink carrier and one or more complementary sidelink carriers; and
receiving sidelink configuration information of the one or more complementary sidelink carriers on the primary sidelink carrier based on the association relationship.

13. The method of claim 12, wherein the association relationship is obtained from any of pre-configured association information and association configuration information received from a network device.

14. The method of claim 12, wherein the receiving sidelink configuration information of the one or more complementary sidelink carriers on the primary sidelink carrier further comprises:
receiving the sidelink configuration information of the one or more complementary sidelink carriers in reserved bits of a physical sidelink broadcast channel carrying the sidelink configuration information of the primary sidelink carrier on the primary sidelink carrier.

15. The method of claim 14, wherein the sidelink configuration information of each of the one or more complementary sidelink carriers occupies the same number of bits.

16. The method of claim 14, wherein the configuration information of a complementary sidelink carrier sharing the same carrier with the primary sidelink carrier occupies fewer bits than other complementary sidelink carriers.

17. The method of claim 12, wherein the receiving sidelink configuration information of the one or more complementary sidelink carriers on the primary sidelink carrier comprises:
receiving the sidelink configuration information of the one or more complementary sidelink carrier on a sidelink data channel of the primary sidelink carrier, the sidelink data channel being located within the same subframe as a physical sidelink broadcast channel carrying the sidelink configuration information of the primary sidelink carrier and a sidelink synchronization signal, and being adjacent thereto in a frequency domain.

18. The method of claim 17, wherein the sidelink data channel is demodulated and decoded based on a same modulation and coding scheme as the physical sidelink broadcast channel.

19. The method of claim 17, further comprising at least one of:
perform a channel estimation based on a received demodulation reference signal sequence for the sidelink data channel and any of a value of Cyclic Redundancy Check (CRC) of the physical sidelink broadcast channel and an identity of the sidelink synchronization signal; or selecting, in response to detection of synchronization signals from a network device providing a synchronization reference and another network device providing an additional synchronization reference, one of the synchronization references based on at least one of: a pre-defined priority for the network device and the other network device, and channel quality measurements for the network device and the other network device.

20. (canceled)

21. The method of claim 12, wherein the one or more complementary sidelink carriers are new radio sidelink carriers and the primary sidelink carrier is a long term evolution sidelink carrier.

22. A terminal device, comprising:
at least one processor; and
at least one memory coupled with the at least one processor;
the at least one memory having computer program codes therein are configured to, when executed on the at least one processor, cause the terminal device at least to perform the method of claim 1.

23-25. (canceled)
